(19) United States
(12) Patent Application Publication
(10) Pub. No.: US 2003/0237002 A1
(43) Pub. Date: Dec. 25, 2003

(54) Network node and communication system

(75) Inventors: Takumi Oishi, Kokubunji (JP); Minoru Hidaka, Kodaira (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/315,930

(22) Filed: Dec. 11, 2002

(30) Foreign Application Priority Data
Jun. 25, 2002 (JP) 2002-184141

(51) Int. Cl. H04L 9/00

(52) U.S. Cl. 713/201

(57) ABSTRACT

The disclosed invention provides a network system that achieves connecting a terminal to a plurality of networks simultaneously and forwarding packets correctly. The network system is built such that an access node connected with a terminal and a network are connected by a relay node and includes an authentication node with which the terminal can communicate and which assigns the terminal an address associated with the network. The address assigned to the terminal is mapped to identification code of the relay node and stored on the access node.

### BACKGROUND OF THE INVENTION

1. Field of the Invention

The present invention relates to network nodes and, more particularly, to nodes that are used for a communications service provider to offer a service of connecting end-user devices to a commercial Internet service provider.

2. Description of Related Art

In recent years, data communications services typified by Internet connection service rapidly have come into common use. Generally, an end user contracts with an access line provider and an Internet Service Provider (ISP) to get the Internet connection service for communication. The access line provider provides a wired or wireless access line and a communications line to an ISP. The ISP provides a communications line to an interconnection point on the Internet, which is called an Internet exchange (IX). To the network of the access line provider, the devices of a plurality of end-users and a plurality of ISPs are connected. Having received a request for connection to an ISP from an end-user device, the access line provider executes routing to properly connect the user device to the ISP and renders the user the data communications service.

A network configuration for conventional data communication services is presented in FIG. 29.

In FIG. 29, equipment at a user home 1 is connected to a Toll center 2 of a communications service provider and the Toll center 2 is connected to ISP-A 4 and ISP-B 5 via a prefectural IP network 3. The ISP-A 4 and ISP-B 5 are connected to the Internet 7 via an Internet Exchange (IX) 6. Inside the user home 1, there are personal computers (PCs) 11 connected to a PPP over Ethernet (PPPoE) enabled router 12. The PPPoE enabled router 12 is a terminal node at which optical fiber lines run inside the user home 1 terminate and this node is connected to an Optical Network Unit 13 which converts electrical signals into optical signals and vice versa. Inside the Toll center 2, an Optical Line Terminal (OLT) 14 at which an optical fiber line terminals and which converts electrical signals into optical signals and vice versa and a Broadband Access Server (BAS) 15 are installed. Within the prefectural IP network 3, an ISP access control node 16 exists. The ISP-A 4 runs an authentication server 17 and the ISP-B 5 runs an authentication server 18.

A procedure for the user to connect its PCs 11 to the Internet is as follows. When the user attempts to connect its device to the Internet, the PPPoE enabled router 12 communicates with the BAS 15 via the ONU 13 and OLT 14 by PPPoE to submit user identification, domain name, and password entered by the user. The BAS 15 receives the PPPoE message conveying the above-mentioned information and determines an ISP that the user attempts to access from the domain name, using the ISP access control node 16. When the access-to-destination ISP has been determined, its authentication server 17 or 18 executes user authentication, using the user identification and password. Once the user has been authenticated, the authentication server 17 or 18 assigns an IP address to the PPPoE enabled router 12. Thereafter, communication via the ISP is performed, using the IP address.

Alternatively, PPPoE software may be installed on the PCs 11 so that the PCs can directly connect to the ONU 13 without the intervention of the PPPoE enabled router 12. In this case, the PCs are assigned an IP address from the ISP that has authenticated the user thereof.

In the above-described data communications service system, an access line provider provides a communications line to an ISP that is a different party from the line provider and the ISP provides the Internet connection service. A disadvantage associated with the method of providing such data communications services is that it is impossible for end users to utilize a plurality of service providers simultaneously.

### SUMMARY OF THE INVENTON

According to one aspect of the invention, a network system is provided which is built such that an access node connected with a terminal and a network are connected by a relay node. The network system includes an authentication node with which the terminal can communicate and which assigns the terminal an address associated with the network, wherein the address assigned to the terminal is mapped to identification code of the relay node and stored on the access node.

According to another aspect of the invention, an access node which connects a terminal to a relay node connected to a network is provided. The access node maps and stores an address associated with the network and assigned to the terminal and identification code of the relay node, and forwards a data packet transmitted from the terminal to the network to the relay node whose identification code has been stored, mapped with the address assigned to the terminal.

According to yet another aspect of the invention, a relay node by which an access node connected with a terminal and a network are connected is provided. The relay node gets an address assigned to the terminal in response to an authentication request from the terminal and maps and stores the address assigned to the terminal and identification code of the access node that relayed the authentication request from the terminal. The relay node forwards a data packet transmitted from the network to the terminal to the access node whose identification code has been stored, mapped to the address assigned to the terminal.

In a further aspect, the invention provides a method of collecting terminal data for use in a network system which is built such that an access node connected with a terminal and a network are connected by a relay node. In this method, the access node performs the following. Upon receiving a user authentication request packet by which the terminal requests access to the network, the access node gets the address of a relay node connecting to the network and forwards the user authentication request packet to the relay node. Upon receiving a user authentication response packet to the user authentication request packet from a relay node, the access node extracts the identification code assigned to the terminal from the user authentication response packet. Moreover, the access node generates the address of the terminal from the identification code and maps and stores the address of the terminal and the address of the relay node.

In a still further aspect, the invention provides a method of collecting terminal data for use in a network system in which an access node connected with a terminal and a network are connected by a relay node, the network system including an authentication node which authenticates the user of the terminal in response to an access request to the network from the terminal. In this method, the relay node performs the following. Upon receiving a user authentication request packet by which the terminal requests access to the network from the access node, the relay node sends the user authentication request packet to the authentication node. Upon receiving a user authentication response packet to the user authentication request packet from the authentication node, the relay node extracts the identification code assigned to the terminal from the user authentication response packet. Moreover, the relay node generates the address of the terminal from the identification code and maps and stores the address of the terminal and the address of the access node.

In a further aspect, the invention provides a method of forwarding data for use in a network system which is built such that an access node connected with a terminal and a network are connected by a relay node, wherein the access node maps and stores the address of the relay node and the address of the terminal and forwards data packets transmitted from the terminal to the network to the relay node whose address has been stored, mapped to the address assigned to the terminal.

In a still further aspect, the invention provides a method of forwarding data for use in a network system which is built such that an access node connected with a terminal and a network are connected by a relay node, wherein the relay node maps and stores the address of the access node and the address of the terminal and forwards data packets transmitted from the network to the terminal to the access node whose address has been stored, mapped to the address assigned to the terminal.

In a further aspect, the invention provides a relay node by which an access node connected with a terminal and a network are connected, wherein the relay node gets an address assigned to the terminal in response to an authentication request from the terminal and maps and stores the address assigned to the terminal and identification code of the access node that relayed the authentication request from the terminal, and forwards a data packet transmitted from the network to the terminal to the access node whose identification code has been stored, mapped to the address assigned to the terminal.

In a further aspect, the invention provides a method of collecting terminal data for use in a network system which is built such that an access node connected with a terminal and a network are connected by a relay node, wherein said access node performs the steps comprising: upon receiving a user authentication request packet by which the terminal requests access to said network, getting the address of a relay node connecting to the network and forwarding the user authentication request packet to the relay node; upon receiving a user authentication response packet to the user authentication request packet from a relay node, extracting identification code assigned to the terminal from the user authentication response packet; generating the address of the terminal from the identification code; and mapping and storing the address of the terminal and the address of the relay node.

In a further aspect, the invention provides a method of collecting terminal data for use in a network system in which an access node connected with a terminal and a network are connected by a relay node, the network system including an authentication node which authenticates the user of the terminal in response to an access request to the network from the terminal, wherein the relay node performs the steps comprising: upon receiving a user authentication request packet by which the terminal requests access to the network from the access node, sending the user authentication request packet to the authentication node; upon receiving a user authentication response packet to the user authentication request packet from the authentication node, extracting identification code assigned to the terminal from the user authentication response packet; generating the address of the terminal from the identification code; and mapping and storing the address of the terminal and the address of the access node.

In a further aspect, the invention provides a method of forwarding data for use in a network system which is built such that an access node connected with a terminal and a network are connected by a relay node, wherein the access node performs the steps comprising: mapping and storing the address of the relay node and the address of the terminal; and forwarding data packets transmitted from the terminal to the network to the relay node whose address has been stored, mapped to the address assigned to the terminal.

In a further aspect, the invention provides a method of forwarding data for use in a network system which is built such that an access node connected with a terminal and a network are connected by a relay node, wherein the relay node performs the steps comprising: mapping and storing the address of the access node and the address of the terminal; and forwarding data packets transmitted from the network to the terminal to the access node whose address has been stored, mapped to the address assigned to the terminal.

The network system of the present invention is built such that an access node connected with a terminal and a network are connected by a relay node and includes an authentication node with which the terminal can communicate and which assigns the terminal an address associated with the network exists, and the address assigned to the terminal is mapped to identification code of the relay node and stored on the access node. Therefore, the network system makes it possible to connect a terminal to a plurality of networks at the same time by request from an end user (for example, different communications facilities of a plurality of service providers or access line providers).

### BRIEF DESCRIPTION OF THE DRAWINGS

FIG. 1 is a diagram representing a network configuration according to a preferred embodiment of the present invention;

FIG. 2 is a diagram representing a hardware configuration of an access gateway and a relay gateway invention;

FIG. 3 illustrates a format of address pair list on an access gateway;

FIG. 4 illustrates a format of address pair list on relay gateway;

FIG. 5 is a diagram representing a hardware configuration of a SP access control server;

FIG. 6 is a diagram representing a configuration of logical functions of the SP access control server;

FIG. 7 is a sequence chart of user authentication by a service provider;

FIG. 8 illustrates an authentication request packet format from a customer possessed equipment (CPE) to an access gateway;

FIG. 9 illustrates a format of IPv6 header;

FIG. 10 illustrates a packet format from an access gateway to a SP access control server;

FIG. 11 illustrates a packet format from the SP access control server to the access gateway;

FIG. 12 illustrates an authentication request packet format from the access gateway to a relay gateway;

FIG. 13 illustrates a format of IPv6 routing option header;

FIG. 14 illustrates an authentication request packet format from the relay gateway to an authentication server;

FIG. 15 illustrates an authentication response packet format from the authentication server to the relay gateway;

FIG. 16 illustrates an authentication response packet format from the relay gateway to the access gateway;

FIG. 17 illustrates an authentication response packet format from the access gateway to the CPE;

FIG. 18 is a sequence chart of steps to be executed on an access gateway in the procedure for user authentication by SP;

FIG. 19 is a diagram representing a configuration of logical functions of an access gateway;

FIG. 20 is a sequence chart of steps to be executed on a relay gateway in the procedure for user authentication by SP;

FIG. 21 is a diagram representing a configuration of logical functions of a relay gateway;

FIG. 22 is a sequence chart of the communication between CPE and corresponding node.

FIG. 23 illustrates a data packet format between CPE and an access gateway and also between a relay gateway and corresponding node (CN);

FIG. 24 illustrates a data packet format between an access gateway and relay gateway;

FIG. 25 is a sequence chart of steps to be executed on an access gateway in the procedure of forwarding a packet originated from CPE;

FIG. 26 is a sequence chart of steps to be executed on an access gateway in the procedure of forwarding a packet bound for CPE;

FIG. 27 is a sequence chart of steps to be executed on a relay gateway in the procedure of forwarding a packet bound for CPE;

FIG. 28 is a sequence chart of steps to be executed on a relay gateway in the procedure of forwarding a packet originated from CPE; and

FIG. 29 is a diagram representing a network configuration of prior art.

### DETAILED DESCRIPTION OF THE PREFERRED EMBODIMENTS

The present invention now is described more fully hereinafter with reference to the accompanying drawings, in which preferred embodiments of the invention are shown.

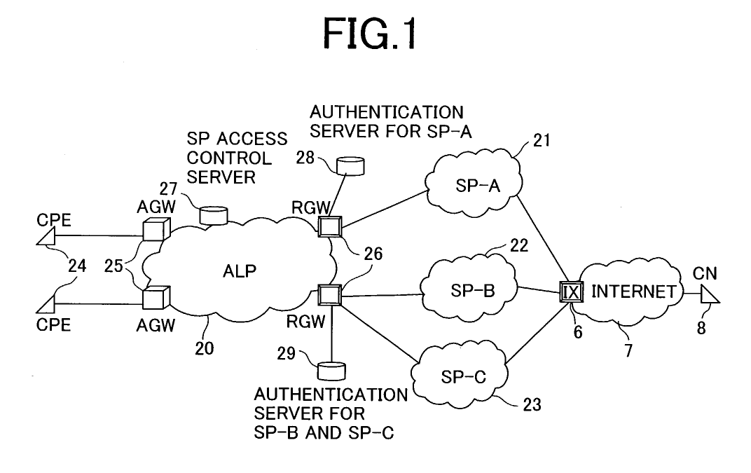

FIG. 1 is a diagram representing a network configuration according to the present invention. Each customer possessed equipment (CPE) 24 existing at their homes is connected to one of the access gateways (AGW) 25 possessed by an access line provider. Each access gateway 25 is connected via a relay gateway (RGW) 26 to service provider A (SP-A) 21, service provider B (SP-B) 22, and service provider C (SP-C) 23. The service provider A 21, service provider B 22, and service provider C 23 are connected to the Internet via an Internet exchange (IX) 6. Within the access line provider's network 20, an SP access control server 27 exists. An authentication server 28 for service provider A is attached to one relay gate 26 connected to service provider A 21 and an authentication server 29 for service provider B and service provider C to another relay gate 26 connected to service provider B 22 and service provider C 23.

A site local address in compliance with IPv6 is assigned to each node: namely, cpes to each customer possessed equipment 24; agws to each access gateway 25; rgws to each relay gateway 26; sccs to the SP access control server 27; asas to the authentication server 28 for service provider A, and asbs to the authentication server 29 for service provider B and service provider C. An SP specified by a customer as an access-to-destination assigns a global scope address of cpeg in compliance with IPv6 to the customer possessed equipment.

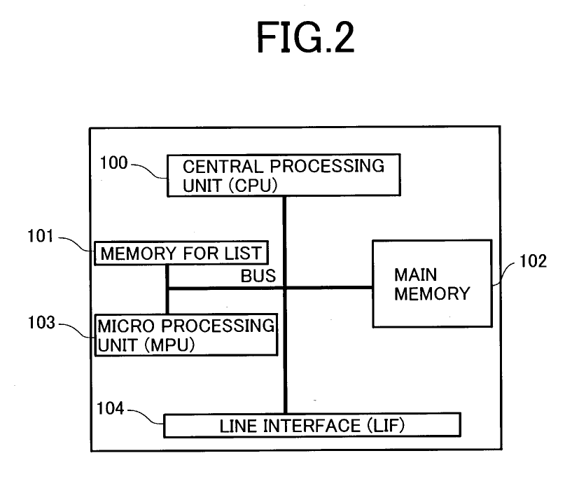

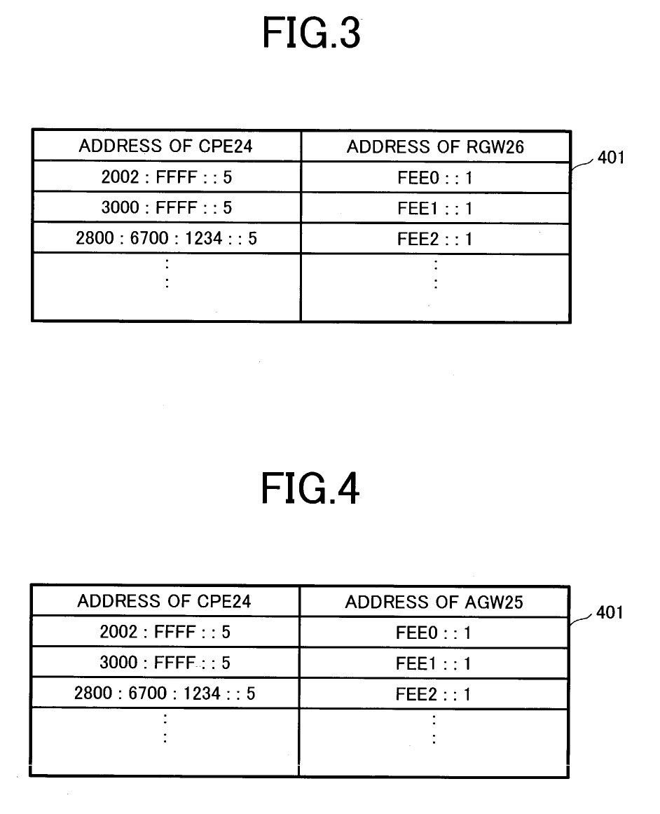

FIG. 2 is a diagram representing a node configuration of an access gateway 24 and relay gateway 26, wherein the node comprises a central processing unit 100, memory for list 101, main memory 102, and micro processing unit 103 which are connected each other via a bus. Both gateways have the same hardware configuration. The access gateway 25 manages pairs of addresses, mapping the address (cpeg) of each customer possessed equipment 24 to the address (rgws) of each relay gateway 26 in the memory for list 101, which is illustrated in FIG. 3. In the address pair list illustrated in FIG. 3, the IP address (global scope address) of each customer possessed equipment 24 mapped to the IP address of each relay gateway 26 is stored. The IP address of each customer possessed equipment 24 is assigned to the customer possessed equipment 24 by the authentication server 28 (as an IPv6 prefix 207) and transmitted in an authentication response packet 305 (FIG. 15) to the appropriate relay gateway 26 and stored there. An address pair list is created on the relay gateway 26.

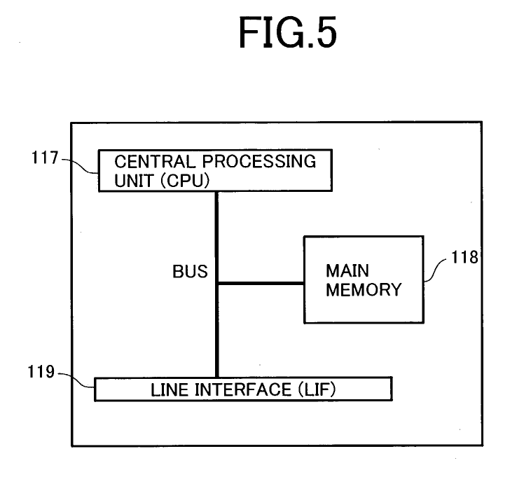

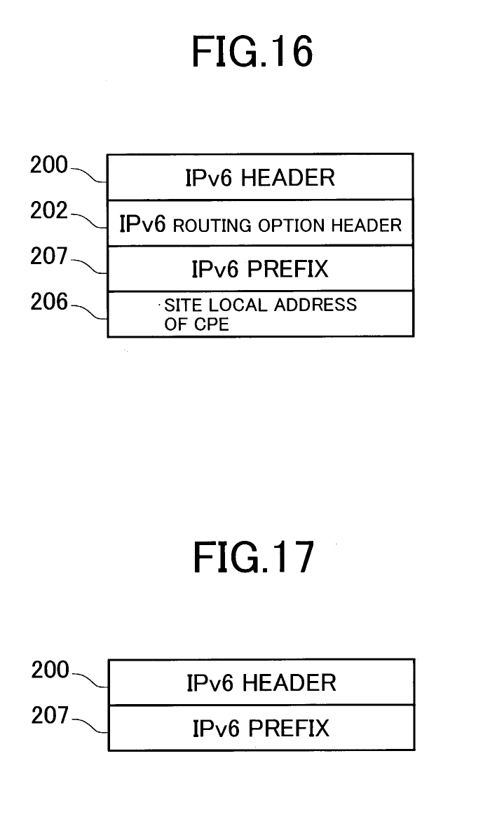

The relay gateway 26 manages an address pair list 401 containing pairs of addresses, mapping the address (cpeg) of each customer possessed equipment 24 to the address (agws) of each access gateway 25 in the memory for list 101, which is illustrated in FIG. 4. In the address pair list illustrated in FIG. 4, the IP address (global address) of each customer possessed equipment 24 mapped to the IP address of each access gateway 25 is stored. The IP address of each customer possessed equipment 24 is assigned to the customer possessed equipment 24 by the authentication server 28 (as an IPv6 prefix 207) and transmitted in an authentication response packet 307 (FIG. 16) to the appropriate access gateway 25 and stored there. The address pair list is created on the access gateway 25.

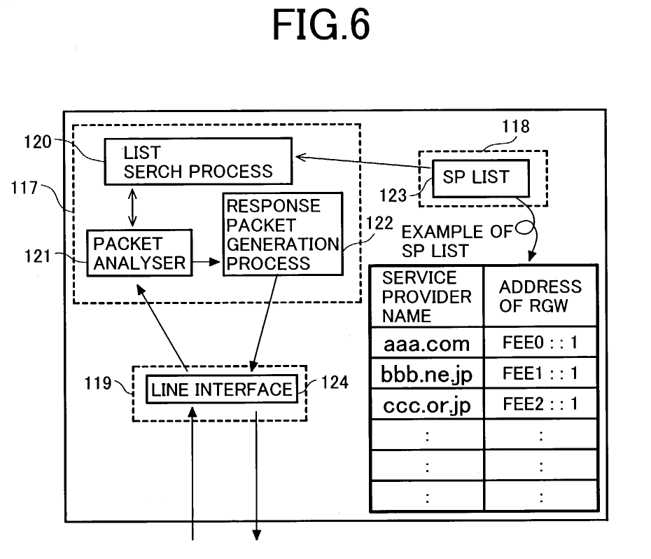

FIG. 5 is a diagram representing a node configuration of the SP access control server 27. FIG. 6 is a diagram representing a configuration of logical functions of the SP access control server 27.

The SP access control server 27 creates an SP list 123 in which it stores and manages pairs of a service provider name (domain name) that an end user is accessing and the IPv6 site local address of a relay gateway 26 that directly connects to the service provider in the main memory 118. The SP list is created in advance and maintained on the SP access control server 27. The address pair list 401 may be either created in advance or created dynamically, according to access requests from end users to service providers, as will be described later for the operation of an access gateway 25 and relay gateway 26.

If an end user is accessing a plurality of service providers simultaneously, it is necessary to determine packet forwarding to which service provider on a per packet basis. Each access gateway 25 and each relay gateway 26 use the address pair list 401 for this purpose. Each access gateway 25 looks for a cpeg entry that matches the source address of an IPV6 packet received and forwards the packet to the relay gateway 26 mapped to the cpeg entry. Each relay gateway 26 looks for a cpeg entry that matches the destination address of an IPv6 packet received and forwards the packet to the access gateway 25 mapped to the cpeg entry. In this way, it is realized for end users to access and utilize a plurality of service providers simultaneously.

If an end user is accessing a plurality of service providers, its customer possessed equipment 24 has a plurality of IPv6 global scope addresses and it is necessary to determine which address is to be used for communication. The application on the equipment uses an IPv6 global scope address assigned by a service provider that the end user wants to utilize as the source address 209. As a method of selecting this address, for example, “default address selection for IPv6” is known. (Refer to http://searcg.uetf,irg.internet-drafts/draft-ietf-ipngwg-default-addr-select-097.txt.)

For the above-mentioned packet forwarding, methods of setting a router (path) for forwarding a packet between an access gateway 25 and a relay gateway 26, using techniques such as Multi Protocol Label Switching (MPLS) and Asynchronous Transfer Mode are known. In the following, however, a procedure for connecting an end user's customer possessed equipment 24 to the Internet, using an IPv6 routing option header, will be described. Information about the IPv6 routing option header is provided in (http://www.ietf.org/rfc/rfc2460.txt, Section 4.4).

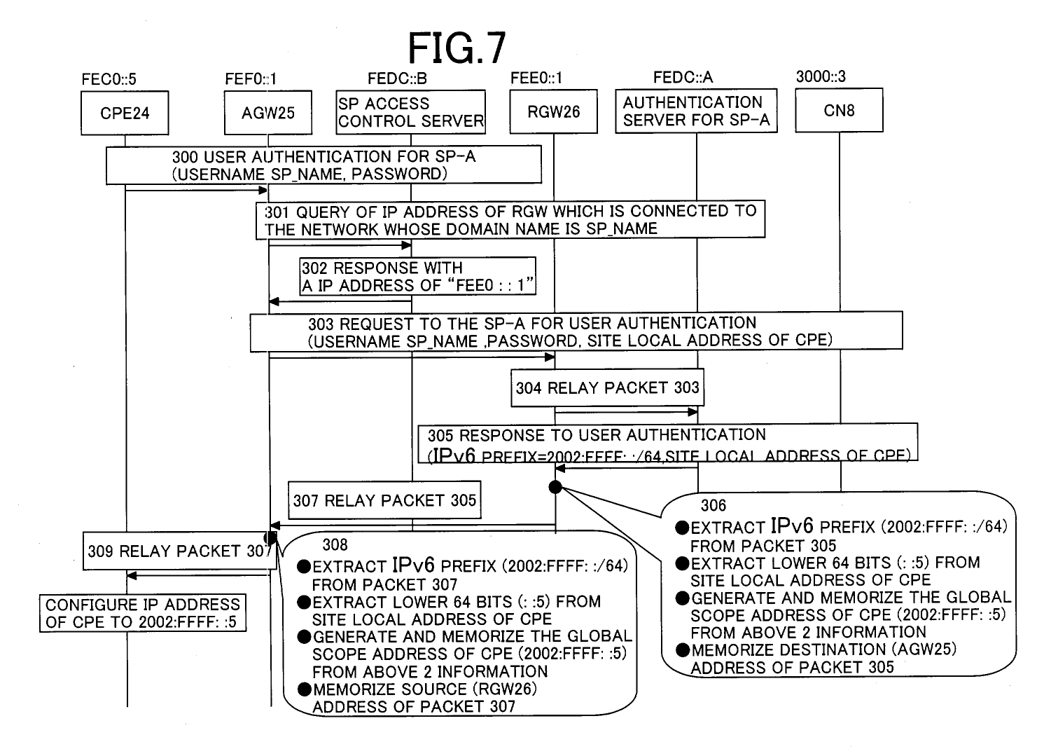

FIG. 7 is a sequence chart representing a user authentication procedure initiated by submission of authentication information to a service provider when an end user attempts to connect its equipment to the Internet.

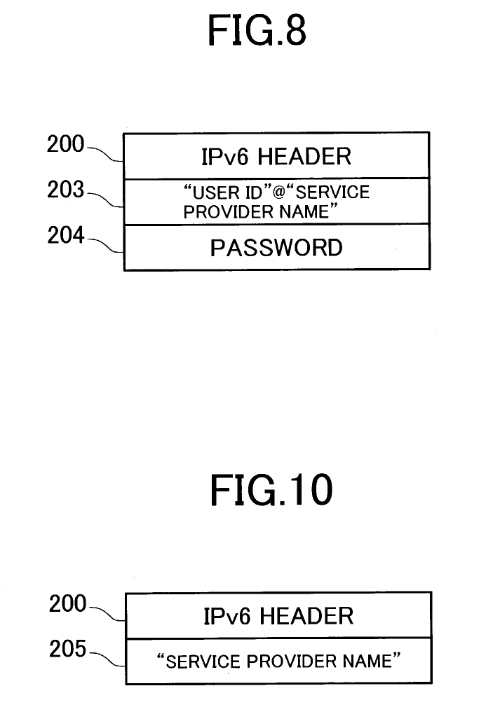

When an end user attempts to connect its equipment to the Internet, the customer possessed equipment 4 transmits a user authentication request packet 300 conveying authentication information to an access gateway 25. The user authentication request packet 300 is structured in a format that is illustrated in FIG. 8 and includes, following an IPv6 header 200, authentication information consisting of user name and service provider A's domain name 203 and password 204. Preferably, the user name 203 and password 204 may be encrypted and transmitted.

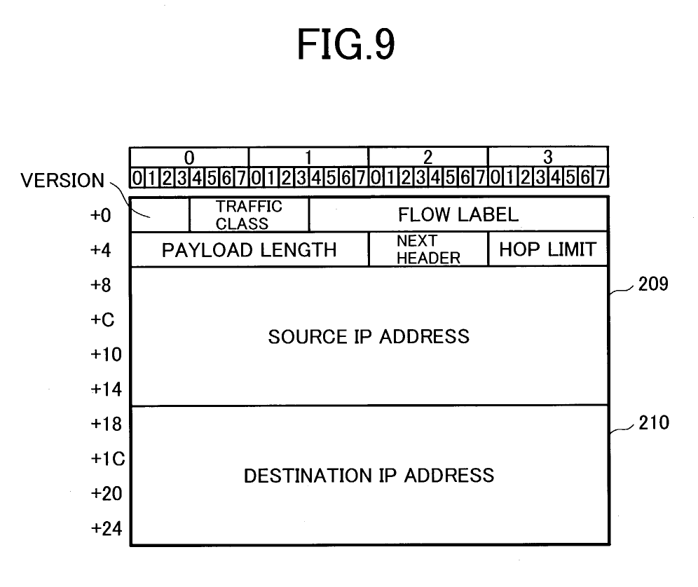

The IPv6 header 200 in the user authentication request packet 300 is structured in a format that is illustrated in FIG. 9. As the source IP address 209, the IP address of the node transmitting the packet (the site local address of the customer possessed equipment 24) is set. As the destination IP address, the IP address of the node to which the packet is transmitted (the authentication server 28 for service provider A) is set.

The access gateway 25 queries the SP access control server 27 about the address of a relay gateway 26 on a route to and located at a connection point of the network 20 to the service provider, connection to which was requested from the customer possessed equipment 24, using an address query packet 301. The address query packet 301 is structured in a format that is illustrated in FIG. 10 and includes, following the IPv6 header 200, the service provider name 205 extracted from the information in the user authentication request packet 300.

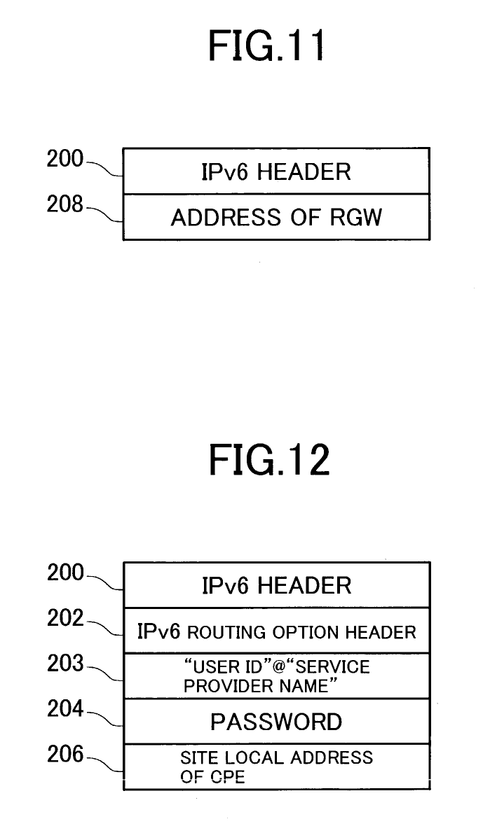

Upon the reception of the above query from the access gateway 25, the SP access control server 27 searches the stored mapping list of relay gateway addresses and service providers for the IP address of the relay gateway 26 mapped to the specified service provider and notifies the access gateway 25 of the address of the relay gateway 26, using an address response packet 302. The address response packet 302 is structured in a format that is illustrated in FIG. 11 and includes, following the IPv6 header 200, the IP address of the relay gateway 26 searched out by the SP access control server 27.

Upon the reception of the address response packet 302, the access gateway 25 transmits a user authentication request packet 303 including authentication information to the relay gateway 26 whose IP address was specified in the packet from the SP access control server 27. The user authentication request packet 303 is structured in a format that is illustrated in FIG. 12 and includes, following the IPv6 header 200, an IPv6 routing option header 202, user name 203, password 204, and the site local address of CPE 206.

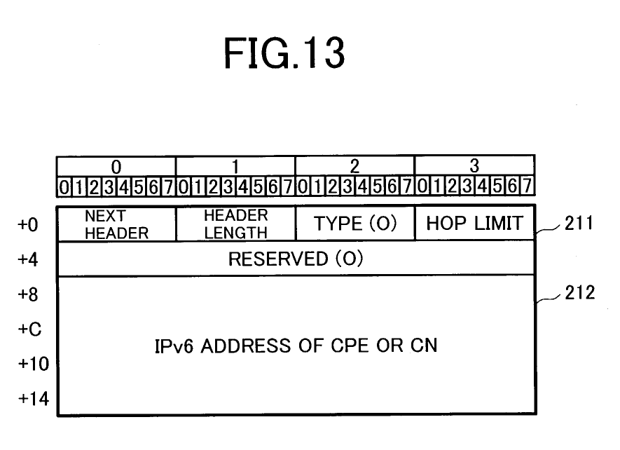

The IPv6 routing option header 202 in the user authentication request packet 303 is structured in a format that is illustrated in FIG. 13 and includes the number of hops 211 and addresses to be routed 212. Specifically, the addresses include the IP address of the relay gateway 26 that the user authentication request packet will transit and will relay this packet and the site local address of the CPE as the source of this packet. The site local address of the CPE is a fixed address assigned to the customer possessed equipment (CPE) 24 (the address constituted by lower 64 bits of its IPv6 address) and is used for routing a return message (authentication response packet) to the customer possessed equipment 24.

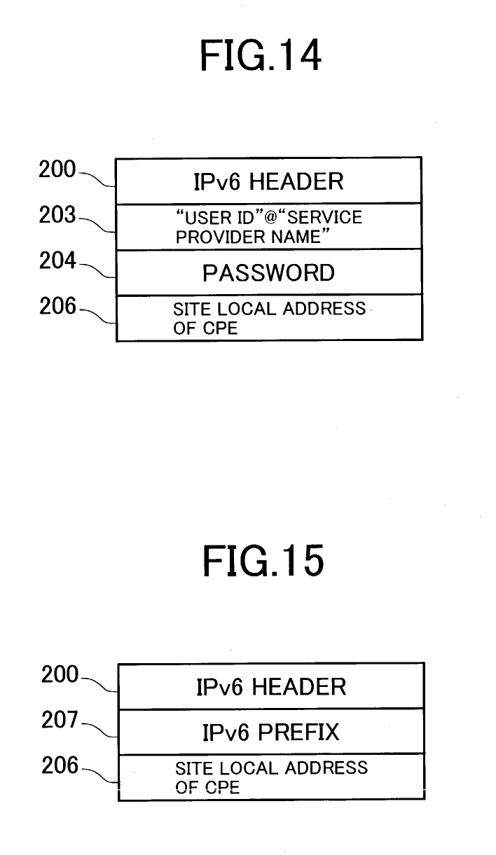

Upon the reception of the user authentication request packet 303, the relay gateway 26 extracts the user name and password from the packet and transmits a user authentication request packet 304 conveying this information to the authentication server 28 for service provider A. The user authentication request packet 304 is structured in a format that is illustrated in FIG. 14 and includes, following the IPv6 header, user name and service provider A's domain name 203, password 204, and the site local address of CPE 206. The site local address of CPE 206 contains the fixed address assigned to the customer possessed equipment (CPE) 24 (the address constituted by lower 64 bits of its IPv6 address). This address is included as is in an authentication response packet (see FIGS. 15 and 16) to be transmitted in response to the user authentication request packet and used by the access gateway 25 and the relay gateway 26 that will have received the authentication response packet to identify the customer possessed equipment 24.

The authentication server 28 for service provider A searches the database in which registered user name and password have been stored. If the registered user name and password matching the received user name and password is found and the user is authenticated, the authentication server assigns an IPv6 global scope address (cpeg) to the customer possessed equipment 24. The authentication server sends hack an authentication response packet 305 conveying the IPv6 global scope address (cpeg). The IPv6 global scope address (cpeg) that is assigned to the customer possessed equipment 24 depends on service provider A and is placed as an address within the network of service provider A so that the customer possessed equipment 24 is linked to the network of service provider A.

The authentication response packet 305 is structured in a format that is illustrated in FIG. 15 and includes, following the IPv6 header 200, an IPv6 prefix 207 and the site local address of CPE 206. The IPv6 prefix 207 contains upper 64 bits of the IPv6 global address assigned to the customer possessed equipment 24. The site local address of CPE 206 is used by the relay gateway 26 that will have received the authentication response packet to identify the customer possessed equipment 24 (determine what user has been authenticated).

Upon the reception of the authentication response packet 305, the relay gateway 26 extracts data of upper 64 bits (2002:FFFF::/64) of the IPv6 address assigned to the customer possessed equipment 24 from the IPv6 prefix. Then, the relay gateway extracts data of lower 64 bits (::5) of the IPv6 address from the site local address of CPE 206. From these two data, the relay gateway determines the IPv6 address (2002:FFFF::5) assigned to the customer possessed equipment. This IPv6 address is mapped to the address of the access gateway 25 to which the authentication response packet is forwarded from the relay gateway 26 and the mapped address pair is stored in the address pair list (see FIG. 3). The access gateway 25 uses this address pair list when determining a forwarded-to-destination of a data packet to arrive at customer possessed equipment 24.

The authentication response packet 305 is relayed by the relay gateway 26 and the access gateway 25 and arrives at the customer possessed equipment 24. This packet is converted to an authentication response packet 307 at the relay gateway 26. The authentication response packet 307 is structured in a format that is illustrated in FIG. 16 and includes, following the IPv6 header 200, an IPv6 routing option header 202, IPv6 prefix 207, and the site local address of CPE 206. The site local address of CPE 206 is used by the access gateway 25 that will have received the authentication response packet to identify the customer possessed equipment 24 (determine what user has been authenticated).

Upon the reception of the authentication response packet 307, the access gateway 25 extracts data of upper 64 bits (2002:FFFF::/64) of the IPv6 address assigned to the customer possessed equipment 24 from the IPv6 prefix 207. Then, the access gateway extracts data of lower 64 bits (::5) of the IPv6 address from the site local address of CPE 206. From both the data, the access gateway determines the IPv6 address (2002:FFFF:5) assigned to the customer possessed equipment 24. This IPv6 address is mapped to the address of the relay gateway 26 from which the authentication response packet 307 has been forwarded and the mapped address pair is stored in the address pair list (see FIG. 4).

Then, the packet is converted to an authentication response packet 309 at the access gateway 25 which is forwarded to the customer possessed equipment 24. The authentication response packet 309 is structured in a format that is illustrated in FIG. 17 and includes, following the IPv6 header 200, an IPv6 prefix 207. The IPv6 prefix 207 contains upper 64 bits of the IPv6 global address assigned to the customer possessed equipment 24. The customer possessed equipment 24 sets the IP address assigned by the authentication server 28, according to the contents of the IPv6 prefix 207.

All the above-mentioned packets 300 through 305, 307, and 309 are for communications using the IPv6 site local address. Through these packets, the customer possessed equipment 24 can perform communication via service provider A 21, using cpeg assigned by the authentication server 28 for the service provider. The above-described procedure is executed each time an end user needs to establish connection to a service provider and the service provider assigns an IP address to the customer possessed equipment 24 that issued the request for connection.

In the following, the operation of an access gateway 25, a relay gateway 26, and the SP access control server 27 will be described in detail.

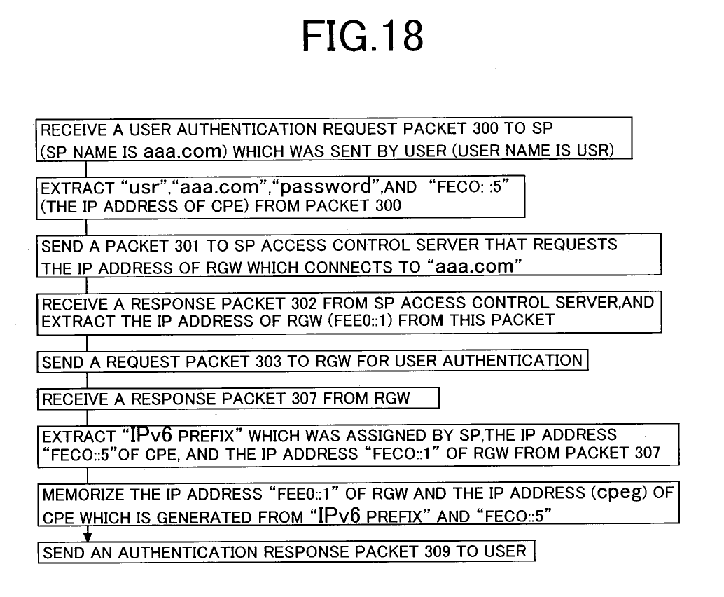

FIG. 18 is a sequence chart of steps to be executed on an access gateway 25 in the procedure for user authentication by SP.

When the access gateway 25 receives a user authentication request packet 300 from a customer possessed equipment 24 (user name “usr”) to a service provider (provider name “aaa.com”), it extracts user name (usr), service provider name (aaa.com), password, and IP address (FEC0::5) of the customer possessed equipment 24 from the user authentication request packet 300.

Then, the access gateway sends the SP access control server 27 an address query packet 301 to inquire about the IPv6 address of a relay gateway 26 that connects to the service provider named “aaa.com”.

After that, when the access gateway receives an address response packet 32 to the address query packet 32 from the SP access control server 27, it gets the IPv6 address of the relay gateway 26 connecting to the service provider named “aaa.com”. Using the IPv6 address of the relay gateway 26 obtained from the SP access control server 27, the access gateway sends a user authentication request packet 303 to the relay gateway 26 having the IPv6 address.

After that, when the access gateway receives a user authentication response packet 307 to the user authentication request packet 303 from the relay gateway 26, it extracts the IPv6 prefix that the SP authentication server 28 assigned to the customer possessed equipment 24, IP address (FEC0::5) of the customer possessed equipment 24, and IP address (FEE0::1) of the relay gateway 26 from the user authentication response packet 307. From the extracted IPv6 prefix and IP address (FEC0::5) of the customer possessed equipment 24, the access gateway generates a global IP address (cpeg) of the customer possessed equipment 24. The access gateway maps the thus obtained global IP address (cpeg) of the customer possessed equipment 24 to the IP address (FEE0::1) of the relay gateway 26 and stores the address pair into the address pair list (see FIG. 3).

After that, the access gateway sends a user authentication response packet 309 to the customer possessed equipment 24.

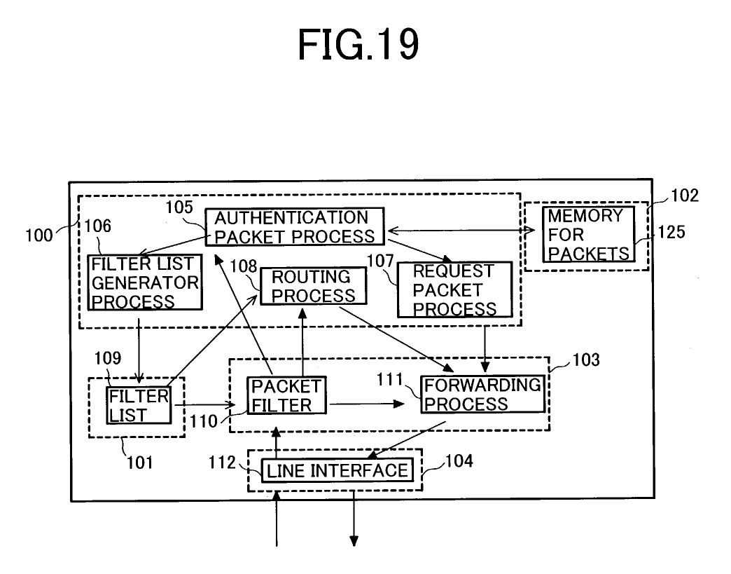

FIG. 19 is a diagram representing a configuration of logical functions of an access gateway 25.

An authentication packet process 105 extracts service provider name, user name, and password from an authentication request packet from an end user and IP address assigned to the CPE of the end user from an authentication response packet received from a relay gateway 26. A filter list generation process 106 generates an IP address list that is used by a packet filter 110. A request packet process 107 generates a query packet to the SP access control server 27 and a packet to be forwarded to a relay gateway 26 when handling a user authentication request packet. A routing process 108 adds or removes a routing option header to/from a packet. A filter list 109 contains the address pair list retaining pairs of addresses, mapping the address assigned by SP to CPE of each end user to the address of the relay gateway 26 connecting to the SP. A packet filter 110 sorts packets received, referring to the filter list 109. A forwarding process 111 forwards a packet. To a line interface 112, a communications line such as Ethernet (a registered trademark) is connected. The line interface 112 receives a packet carried across the communications line and arrived at the access gateway and transmits a packet over the communications line.

The packet filter 110 checks the payload of a packet received and passes the packet to the appropriate component of the access gateway 25, according to the packet type. For example, if the received packet is a user authentication request packet, RGW address response packet, or authentication response packet, the packet filter passes it to the authentication packet process 105. If the received packet is a packet originated from CPE or a packet bound for CPE, the packet filter passes it to the routing process 108.

By sorting, the packet filter 110 passes a user authentication request packet to the authentication packet process 105. The authentication packet process 105 extracts the service provider's domain name from the payload and passes it to the request packet process 107. The request packet process 107 generates an address query packet 301 conveying the service provider's domain name to the SP access control server 27, setting sccs for the destination and agws for the source of the packet. This packet to inquiry about the IP address of a relay gateway 26 connecting to the service provider identified from the service provider's domain name is passed to the forwarding process 111.

From the destination address 210 of the packet, the forwarding process 111 determines a next-hop router to which to forward the packet and passes the packet to the line interface 112. The line interface 112 transmits the address query packet 301.

The received user authentication request packet is saved to a memory for packets 125.

By sorting, the packet filter 110 passes an RGW address response packet 302 to the authentication packet process 105. The authentication packet process 105 extracts the IPv6 address of the relay gateway from the payload 201 of the RGW address response packet 302 and passes this address together with the associated user authentication request packet saved to the memory for packets 125 to the request packet process 107. At this time, the user authentication request packet 300 saved to the memory for packets 125 is retrieved and passed to the request packet process 107.

Based on the user authentication request packet 300, the request packet process 107 generates a user authentication request packet 303, setting rgws for the destination address and agws for the source address of the packet. This packet is passed to the forwarding process 111.

From the destination address 210 of the packet, the forwarding process 111 determines a next-hop router to which to forward the packet and passes the packet to the line interface 112. The line interface 112 transmits the user authentication request packet 303.

By sorting, the packet filter 110 passes an authentication response packet 307 to the authentication packet process 105. The authentication packet process 105 extracts the IPv6 prefix and site local address (cpes) of CPE from the payload 201 of the authentication response packet 307 and the address (rgws) of the relay gateway from the IPv6 header and passes them to the filter list generation process 106. The filter list generation process 106 generates the IPv6 global address (cpeg) of the customer possessed equipment 24 from the IPv6 prefix and site local address (cpes) of CPE and passes the cpeg together with the rgws to the filter list 109. The cpeg and rgws values are mapped and stored into the filter list 109 so that the rgws value can be obtained by the cpeg key.

The authentication response packet 307 is also passed to the request packet process 107. Based on the authentication response packet 307, the request packet process 107 generates a user authentication response packet 309 with its destination address changed to cpes and source address changed to agws and passes this packet to the forwarding process 111.

From the destination address 210 of the packet, the forwarding process 111 determines a next-hop router to which to forward the packet and passes the packet to the line interface 112. The line interface 112 transmits the user authentication response packet 309.

By sorting, the packet filter 110 passes an authentication response packet to the authentication packet process 105. The authentication packet process 105 extracts the IPv6 prefix and site local address (cpes) of CPE from the payload of the packet and the address (rgws) of the relay gateway from the IPv6 header and passes them to the filter list generation process 106. The filter list generation process 106 combines the IPv6 prefix and the cpes into the IPv6 global address (cpeg) of the customer possessed equipment 24 and passes the cpeg together with the rgws to the filter list 109. The cpeg and rgws values are mapped and stored into the filter list 109 so that the rgws value can be obtained by the cpeg key.

The authentication response packet is also passed to the request packet process 107. Based on the authentication response packet, the request packet process 107 generates a user authentication response packet 309, setting cpes for the destination address and agws for the source address of the packet. This packet is passed to the forwarding process 111.

The forwarding process 111 determines a next-hop router to which to forward the packet and passes the packet to the line interface 112. The line interface 112 transmits the authentication response packet addressed to the customer possessed equipment 24.

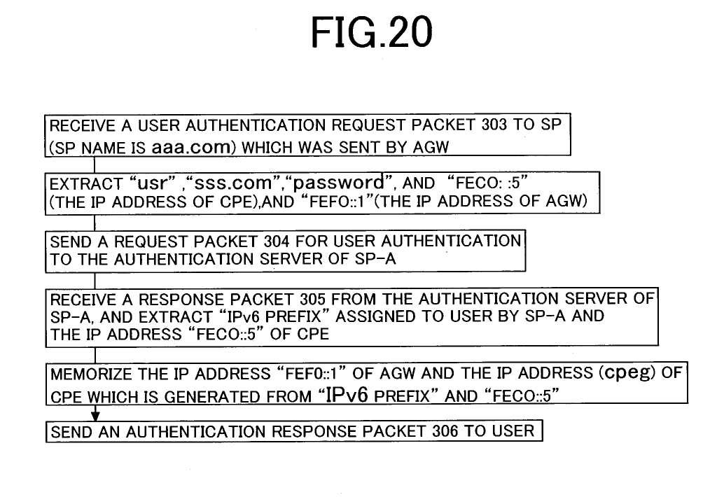

FIG. 20 is a sequence chart of steps to be executed on a relay gateway in the procedure for user authentication by SP.

When a relay gateway 62 receives a user authentication request packet 303 to a service provider (provider name “aaa.com”) from an access gateway 25, it extracts user name (usr), service provider name (aaa.com), password, IP address (FEC0::5) of the customer possessed equipment 24, and IP address (FEF0::1) of the access gateway 25 from the user authentication request packet 303.

Then, the relay gateway generates a user authentication request packet 304 including the user name (usr) and password and sends the user authentication request packet 304 to the authentication server 28 for service provider A.

After that, when the relay gateway receives a user authentication response packet 305 to the user authentication request packet 304 from the authentication server 28 for service provider A, it extracts the IPv6 prefix that the SP authentication server 28 assigned to the customer possessed equipment 24 and IP address (FEC0::5) of the customer possessed equipment 24 from the user authentication response packet 305. From the extracted IPv6 prefix and IP address (FEC0::5) of the customer possessed equipment 24, the relay gateway generates a global IP address (cpeg) of the customer possessed equipment 24. The relay gateway maps the thus obtained global IP address (cpeg) of the customer possessed equipment 24 to the IP address (FEF::1) of the access gateway 25 and stores the address pair into the address pair list (see FIG. 4).

After that, the relay gateway sends a user authentication response packet 306 to the access gateway 25.

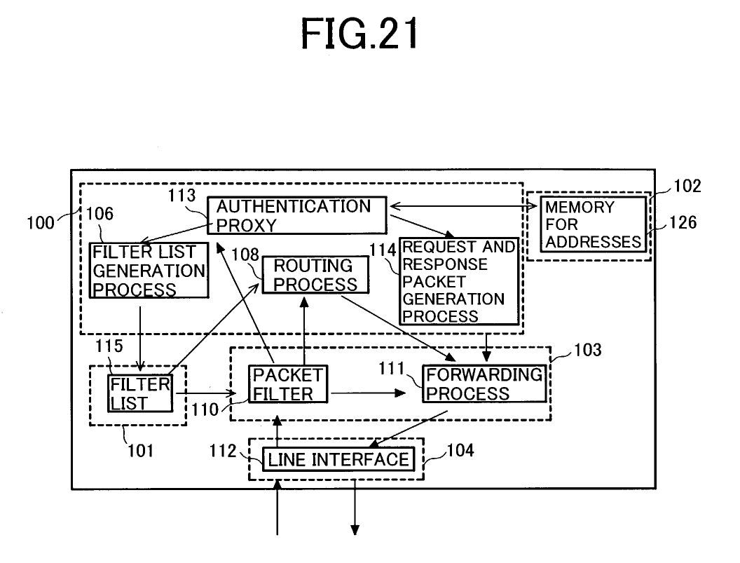

FIG. 21 is a diagram representing a configuration of logical functions of a relay gateway 26.

A authentication proxy 113 extracts service provider name, user name, and password from an authentication request packet from an access gateway 25 and IP address assigned to the CPE of the end user from an authentication response packet received from the authentication server 28 for service provider A. A filter list generation process 106 generates an IP address list that is used by a packet filter 110. A request and response packet generation process 114 generates a user authentication request packet to the authentication server 28 for service provider A and a user authentication response packet to be forwarded to an access gateway 25. A routing process 108 adds or removes a routing option header to/from a packet. A filter list 115 contains the address pair list retaining pairs of addresses, mapping the address assigned by SP to CPE of each end user to the address of the access gateway 25 to which the CPE connects. A packet filter 110 sorts packets received, referring to the filter list 115. A forwarding process 111 forwards a packet. To a line interface 112, a communications line such as Ethernet (a registered trademark) is connected. The line interface 112 receives a packet carried across the communications line and arrived at the relay gateway and transmits a packet over the communications line.

The packet filter 110 checks the payload of a packet received and passes the packet to the appropriate component of the relay gateway 26, according to the packet type. For example, if the received packet is a user authentication request packet 303 or authentication response packet 305, the packet filter passes it to the authentication proxy 113. If the received packet is a packet sent by user 313 or a packet bound for user 316, the packet filter passes it to the routing process 108.

By sorting, the packet filter 110 passes a user authentication request packet 303 to the authentication proxy 113. The authentication proxy 113 extracts the source address 209, namely, the address (aqws) of the access gateway 25 from the IPv6 header 200 of the user authentication request packet 303 and saves the agws to the memory for addresses.

Then, the user authentication request packet 303 is passed to the request and response packet generation process 114. Based on the user authentication request packet 303, the request and response packet generation process 114 generates a user authentication request packet 304 with the destination changed to the authentication server 28 (asas) for SP-A and the source changed to the relay gateway 26 (rgws). This packet addressed to the authentication server 28 for service provider A is passed to the forwarding process 111.

From the destination address of the packet, the forwarding process 111 determines a next-hop router to which to forward the packet and passes the packet to the line interface 112. The line interface 112 transmits the user authentication request packet 304.

By sorting, the packet filter 110 passes an authentication response packet 305 to the authentication proxy 113. The authentication proxy 113 extracts the IPv6 prefix and site local address (cpes) of CPE from the payload 201 of the authentication response packet 305 and passes them together with the address (agws) of the access gateway 25 saved before to the memory for addresses 126 to the filter list generation process 106. The authentication response packet 305 and the address (agws) of the access gateway 25 are passed to the request and response packet generation process 114. The filter list generation process 106 combines the IPv6 prefix and the site local address (cpes) of CPE into a global address (cpeg) of CPE and passes the cpeg together with the agws to the filter list 115. The cpeg and agws values are mapped and stored into the filter list 115 so that the agws value can be obtained by the cpeg key.

Based on the authentication response packet 305, the request and response packet generation process 114 generates an authentication response packet with the destination changed to agws and the source changed to rgws and passes this packet to the forwarding process 111. From the destination address of the packet, the forwarding process 111 determines a next-hop router to which to forward the packet and passes the packet to the line interface 112. The line interface 112 transmits the authentication response packet 306.

Then, the function of the SP access control server 27 will be explained, using FIG. 6.

A packet analyzer 121 extracts service provider name from a packet. A response packet generation process 122 generates a response packet including the IP address obtained by a list search process 120. An SP list 123 retains the mapping between a service provider name and the IP address of a relay gateway 26 connecting to the service provider. To a line interface 124, a communications line such as Ethernet (a registered trademark) is connected. The line interface 124 receives a packet carried across the communications line and arrived at the server and transmits a packet over the communications line.

When a packet (address query) arrives at the SP access control server 27, the line interface 124 receives the packet and the packet analyzer 121 checks its payload 201. The packet analyzer 121 extracts service provider's domain name from the packet and passes it to the list search process 123. The list search process 120 searches the SP list for the extracted domain name. If an entry matching that domain name is found, the list search process returns the IPv6 address of the relay gateway 26 mapped to the SP entry to the packet analyzer 121. The packet analyzer 121 passes the obtained IPv6 address and the address query packet 301 to the response packet generation process 122. The response packet generation process 122 generates an address response packet 302 in which the IPv6 address is stored into the payload 201, the address (agws) of the access gateway 25 is set for the destination, and the address (sccs) of the SP access control server 27 is set for the source. The address response packet 302 is passed to the line interface 124. The line interface 124 transmits the address response packet 302.

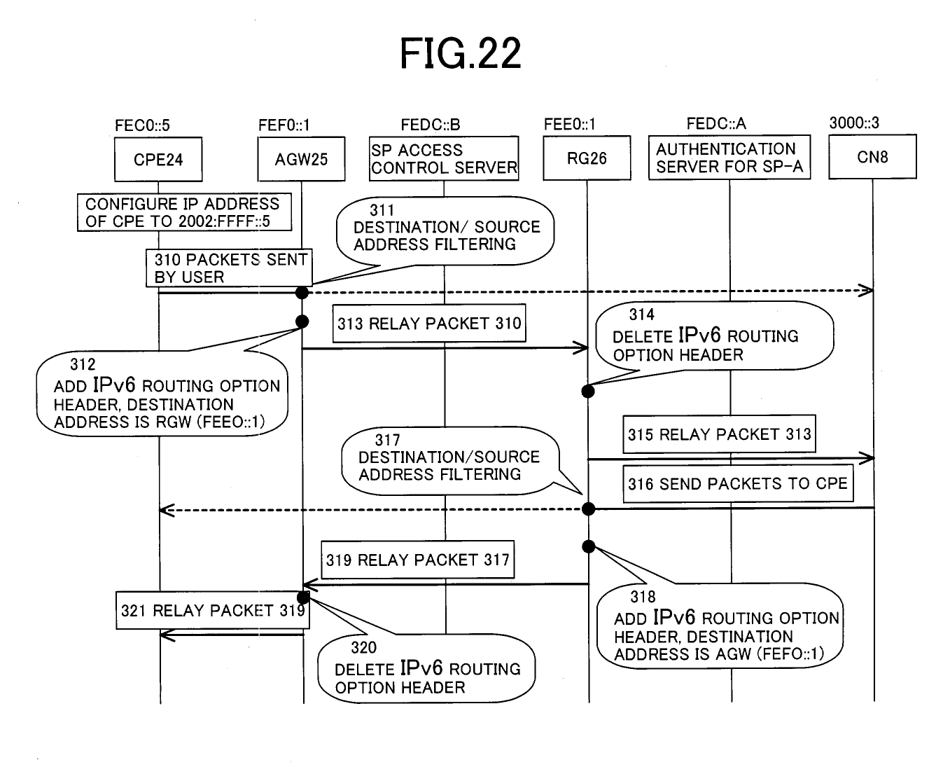

FIG. 22 is a sequence chart of the procedure in which an end user actually performs communication via service provider A 21.

The customer possessed equipment 24 transmits a packet sent by user 310 in which cpeg is set for the source address 209 (see FIG. 9). The access gateway 25 that received the packet searches the filter list 109, according to the source address (cpeg) 209. If an entry matching the cpeg exists (step 311), the access gateway generates a modified packet sent by user 313 to which a routing option header 202 is added and in which the address of the relay gateway 26 mapped to the cpeg is set for the destination (step 312) and sends this packet to the relay gateway 26.

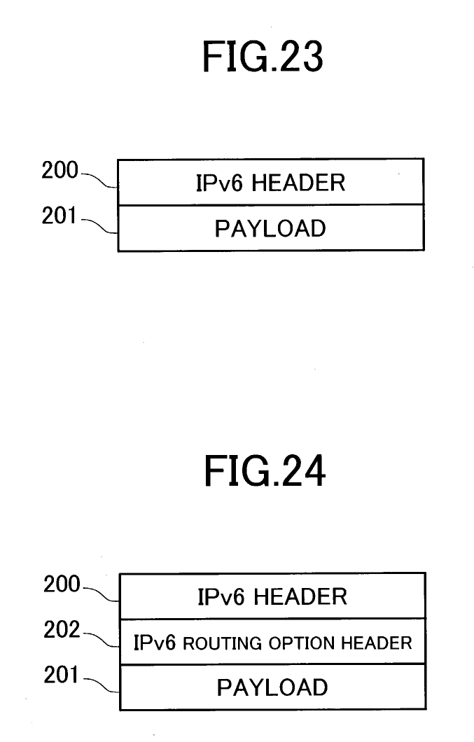

The packet sent by user 310 is structured in a format that is illustrated in FIG. 23 and includes, following the IPv6 header 200, the payload 201 which is the data part. The modified packet sent by user 313 is structured in a format that is illustrated in FIG. 24 and includes, following the IPv6 header 200, the IPv6 routing option header 202 and the payload 201 which is the data part.

Upon the reception of the modified packet sent by user 131, the relay gateway 26 removes the IPv6 routing option header 202 (step 314), generates a re-modified packet sent by user 315, and sends this packet to a corresponding node. The re-modified packet sent by user 315 is structured in the format illustrated in FIG. 23; that is, it includes, following the IPv6 header 200, the payload 201 which is the data part, but does not include the IPv6 routing option header.

When the corresponding node (CN) 8 replies to the re-modified packet sent by user 315 it received, it sends a packet bound for user 316 in which cpeg is set for the destination address 210 (see FIG. 9) in the IPv6 header. The relay gateway 26 that received this packet searches the filter list 115 for the destination address (cpeg) 210. If an entry matching the cpeg exists (step 317), the relay gateway generates a modified packet bound for user 319 to which a routing option header 202 is added and in which the address of the access gateway 25 is set for the destination (step 318) and sends this packet to the access gateway 25.

The packet bound for user 316 is structured in the format illustrated in FIG. 23; that is, it includes, following the IPv6 header 200, the payload 201 which is the data part, but does not include the IPv6 routing option header. The modified packet bound for user 319 is structured in the format illustrated in FIG. 24; that is, it includes, following the IPv6 header 200, the IPv6 routing option header 202 and the payload 201 which is the data part.

Upon the reception of the modified packet bound for user 319, the access gateway 25 removes the IPv6 routing option header 202 from the packet (step 320), generates a re-modified packet bound for user 321, and sends this packet to the customer possessed equipment 24. The re-modified packet bound for user 321 is structured in the format illustrated in FIG. 23; that is, it includes, following the IPv6 header 200, the payload 201 which is the data part, but does not included the IPv6 routing option header.

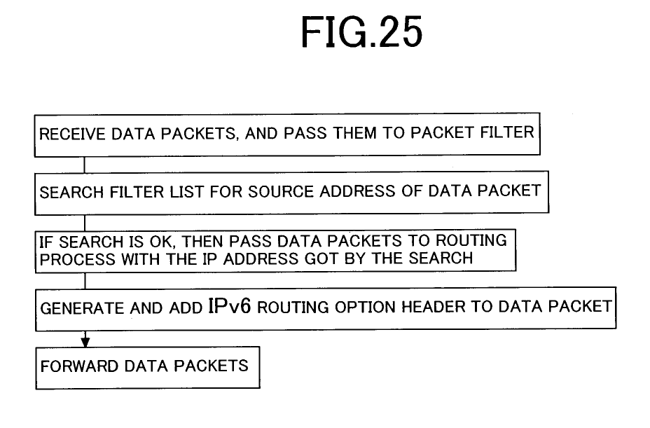

FIG. 25 is a sequence chart of steps to be executed on an access gateway 25 in the procedure of forwarding a data packet originated from customer possessed equipment 24 (steps 311 and 312 of FIG. 22).

For a packet received by the line interface 112, the packet filter 110 checks its type. If the packet type is a packet sent by user 310, the packet filter 110 searches the filter list 109 for the source address of the packet sent by user 310. As the result of search, if the filter list 109 includes the source address and address matching is found, the IPv6 address (rgws) mapped to the source address and the packet sent by user 310 are passed to the routing process 108.

The routing process 108 generates a modified packet sent by user 313 to which a routing option header 202 is added. Instead of the IPv6 address of the corresponding node (CN) 8, rgws is set for the destination address 210 of this data packet and the IPv6 address of the corresponding node (CN) 8 is specified for the address within the extension header 212.

Then, the forwarding process 111 and the line interface 112 execute packet forwarding. That is, the modified packet sent by user 313 is passed to the forwarding process 111. From the destination address 210 of the packet, the forwarding process 111 determines a next-hop router to which to forward the packet and passes the packet to the line interface 112. The line interface 112 transmits the packet.

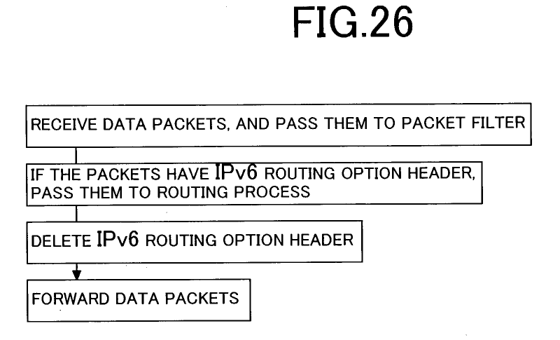

FIG. 26 is a sequence chart of steps to be executed on an access gateway 25 in the procedure of forwarding a data packet bound for customer possessed equipment 24 (step 320 of FIG. 22).

For a packet received by the line interface 112, the packet filter 110 checks its type. If the packet type is a modified packet bound for user 319, the packet filter 110 passes the packet bound for user 319 to the routing process 108. The routing process 108 removes the routing option header 202, if attached, from the packet bound for user 319 and generates a re-modified packet bound for user 321 in which the address copied from the address within the extension header 212 is set for the destination address 210.

Then, the forwarding process 111 and the line interface 112 execute packet forwarding. That is, the re-modified packet bound for user 321 is passed to the forwarding process 111. From the destination address of the packet, the forwarding process 111 determines a next-hop router to which to forward the packet and passes the packet to the line interface 112. The line interface 112 transmits the packet.

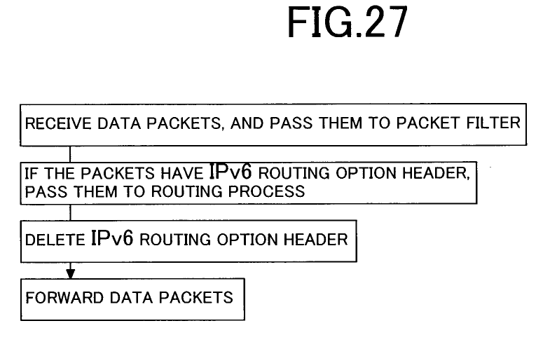

FIG. 27 is a sequence chart of steps to be executed on a relay gateway 26 in the procedure of forwarding a data packet originated from customer possessed equipment 24 (step 314 of FIG. 22).

For a packet received by the line interface 112, the packet filter 110 checks its type. If the packet type is a modified packet sent by user 313, the packet filter 110 passes the packet sent by user 313 to the routing process 108. The routing process 108 removes the routing option header 202, if attached, from the packet sent by user 313 and generates a re-modified packet sent by user 315 in which the address copied from the address within the extension header 212 is set for the destination address 210.

Then, the forwarding process 111 and the line interface 112 execute packet forwarding. That is, the re-modified packet sent by user 315 is passed to the forwarding process 111. From the destination address of the packet, the forwarding process 111 determines a next-hop router to which to forward the packet and passes the packet to the line interface 112. The line interface 112 transmits the packet.

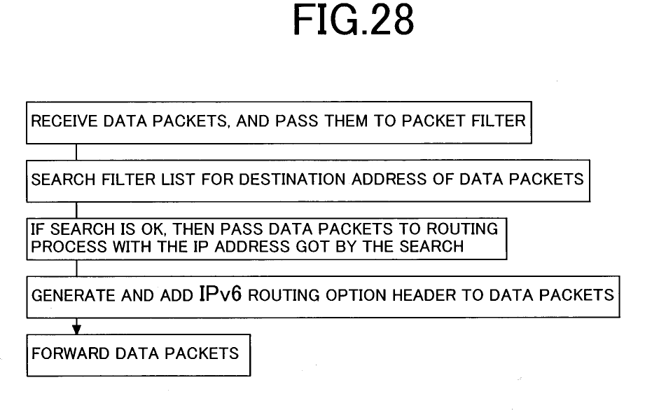

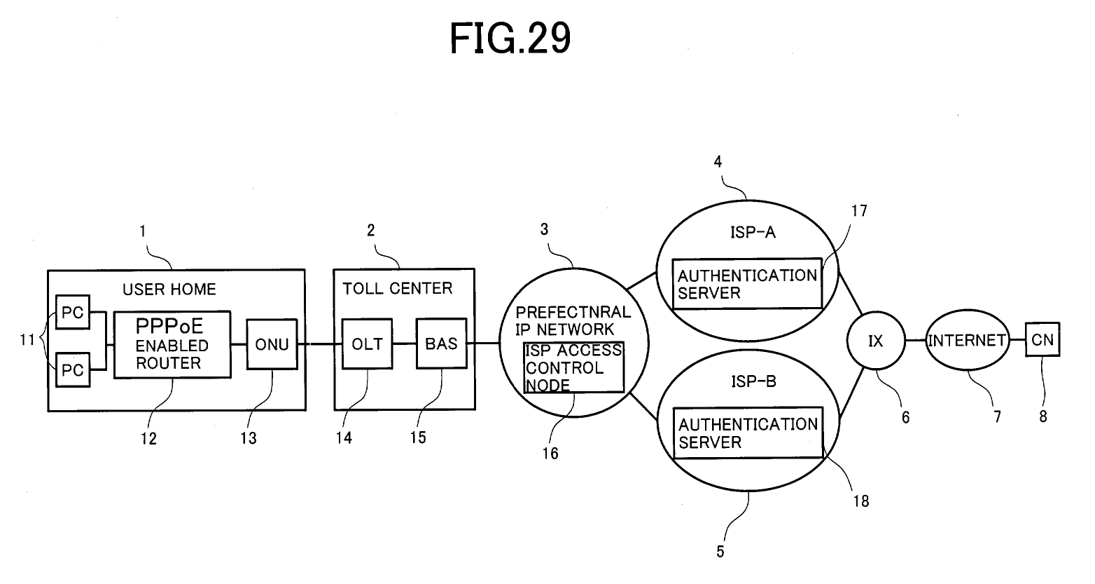

FIG. 28 is a sequence chart of steps to be executed on a relay gateway 26 in the procedure of forwarding a data packet bound for customer possessed equipment 24 (steps 317 and 318 of FIG. 22).

For a packet received by the line interface 112, the packet filter 110 checks its type. If the packet type is a packet bound for user 316, the packet filter 110 searches the filter list 115 for the destination address of the packet bound for user 316. As the result of search, if the filter list 115 includes the destination address and address matching is found, the IPv6 address (agws) mapped to the destination address and the packet bound for user 316 are passed to the routing process 108.

The routing process 108 generates a modified packet bound for user 319 to which a routing option header 202 is added. Instead of the IPv6 address (cpeg) of the customer possessed equipment 24, agws is set for the destination address 210 of this data packet and the IPv6 address (cpeg) of the customer possessed equipment 24 is specified for the address within the extension header 212.

Then, the forwarding process 111 and the line interface 112 execute packet forwarding. That is, the modified packet bound for user 319 is passed to the forwarding process 111. From the destination address 210 of the packet, the forwarding process 111 determines a next-hop router to which to forward the packet and passes the packet to the line interface 112. The line interface 112 transmits the packet.

In the preferred embodiment of the present invention, as described hereinbefore, in the network environment using the IPv6 network protocol, when a plurality of terminals (CPEs) are accessing a plurality of networks (service providers), a terminal submits a user authentication request to the authentication node of a service provider that the terminal attempts to access. Once the terminal has been assigned an IP address, a communication path between the terminal and the service provider is established. This network system includes an access node (AGW) connecting with each terminal and a relay node (RGW) connecting to each network and, therefore, makes it possible to connect a terminal to a plurality of networks at the same time by request from an end user, (for example, different communications facilities of a plurality of service providers or access line providers).

An access node is provided with the following functions: managing pairs of addresses, mapping the address of a terminal assigned by the authentication node to the address of the relay node through which packets are carried between the destination network and the terminal; routing a packet between the access node and a relay node, according to the address pair list; relaying packets for the authentication procedure between a terminal and the authentication node; and generating a pair of addresses, using the function of relaying packets for the authentication procedure. The access node forwards data packets sent from a terminal to a network to the appropriate relay node, using the address pair list stored thereon. Thus, even when the terminal is connecting to a plurality of networks simultaneously, packets originated from the terminal can be correctly routed and forwarded.

A relay node is provided with the following functions: managing pairs of addresses, mapping the address of a terminal assigned by the authentication node to the address of the access node connecting with the terminal; routing a packet between the relay node and an access node, according to the address pair list; relaying packets for the authentication procedure between a terminal and the authentication node; and generating a pair of addresses, using the function of relaying packets for the authentication procedure. The relay node forwards data packets sent from a network to a terminal to the appropriate access node, using the address pair list stored thereon. Thus, even if the address assigned to the terminal is the one within a network, data packets addressed to the terminal are not returned to the network after being arrived at the relay node. Even when the terminal is connecting to a plurality of networks simultaneously, packets can be correctly forwarded.

An access node forwards data packets transmitted from a terminal to a network to the appropriate relay node connecting to the network, using the address pair list stored thereon. On the other hand, a relay node forwards data packets transmitted from a network to a terminal to the appropriate access node connecting with the terminal, using the address pair list stored thereon. Thus, there remains the same path through which packets are sent from a terminal and the terminal receives packets and it makes it possible for an end user terminal to communicate with a plurality of communications facilities of service providers at the same time.

The SP access control server is provided with a database enabling a search for a relay node connecting to the target network from the network name (for example, service provider name). Correct information can be obtained about the addresses of the relay nodes mapped to a plurality of networks.

What is claimed is:

1. A network system which is built such that an access node connected with a terminal and a network are connected by a relay node, said network system including an authentication node with which said terminal can communicate and which assigns said terminal an address associated with said network, wherein the address assigned to said terminal is mapped to identification code of said relay node and stored on said access node.

2. A network system according to claim 1 further including a control node with which said access node can communicate, on which mapping between said network and the identification code of said relay node is stored, and which returns the identification code of said relay node in response to a query from said access node.

3. A network system according to claim 2, wherein:
said authentication node assigns an address to said terminal in response to an authentication request from said terminal and the address assigned to said terminal is transmitted to said terminal through a path on which said relay node and said access node are receivable.

4. A network system according to claim 3, wherein the address assigned to said terminal is mapped to the identification code of a relay node that relayed transmission of the address assigned to said terminal and stored on said access node.

5. A network system according to claim 4, wherein said access node forwards data packets transmitted from said terminal to said network to said relay node whose identification code has been stored, mapped to the address assigned to said terminal.

6. A network system according to claim 3, wherein the address assigned to said terminal is mapped to the identification code of an access node that relayed the authentication request from said terminal and stored on said relay node.

7. A network system according to claim 3, wherein said relay node forwards data packets transmitted from said network to said terminal to said access node whose identification code has been stored, mapped to the address assigned to said terminal.

8. A network system comprising networks providing information to terminals, access nodes connecting with said terminals, relay nodes by which said access nodes and said networks are connected respectively, and authentication nodes which authenticate the user of a terminal to permit access to one of said networks,
wherein a terminal submits an authentication request to the authentication node of a network to which it needs to have access and a communication path is established between said terminal and the network when the authentication is completed,
wherein an access node manages mapping between an address assigned to a terminal and the address of a relay node, using a user authentication packet transmitted from one of said authentication nodes, and
wherein a relay node manages mapping between an address assigned to a terminal and the address of an access node, using a user authentication packet transmitted from one of said authentication nodes.

9. A network system according to claim 8, wherein:
said access node receives a data packet transmitted from a terminal to a network and changes the destination of the data packet to a relay node whose address has been stored, mapped to the address assigned to the terminal, and
said relay node receives a data packet transmitted from a network to a terminal and changes the destination of the data packet to an access node whose address has been stored, mapped to the address assigned to the terminal.

10. An access node which connects a terminal to a relay node connected to a network,
said access node mapping and storing an address associated with said network and assigned to said terminal and identification code of said relay node, and
said access node forwarding a data packet transmitted from said terminal to said network to said relay node whose identification code has been stored, mapped with the address assigned to said terminal.

11. An access node according to claim 10, wherein said access node submits a request for the identification code of said relay node to a control node where the identification code of said relay node has been stored, gets the identification code of said relay node from said control node, and stores the identification code.

12. An access node according to claim 10, wherein said access node gets and stores the identification code of a relay node that relayed transmission of the address assigned to said terminal.

13. An access node according to any one of claims 10 through 12, wherein said access node gets and stores the address assigned to the terminal by said authentication node in response to an authentication request from said terminal.
